(19) United States
(12) Patent Application Publication
(10) Pub. No.: US 2013/0038787 A1
(43) Pub. Date: Feb. 14, 2013

(54) IMAGE PICK-UP APPARATUS

(71) Applicant: CHUN-YU LEE, Tu-Cheng (TW)

(72) Inventor: CHUN-YU LEE, Tu-Cheng (TW)

(73) Assignee: HON HAI PRECISION INDUSTRY CO., LTD., Tu-Cheng (TW)

(21) Appl. No.: 13/532,802

(22) Filed: Jun. 26, 2012

(30) Foreign Application Priority Data
Aug. 10, 2011 (TW) 100128621

(51) Int. Cl. H04N 5/225

(52) U.S. Cl. 348/374; 348/E05.025

(57) ABSTRACT

An image pick-up apparatus to reduce glare includes a lens module, a light shielding plate and an image sensor. The lens module includes a lens barrel and a base plate. The base plate defines a first through hole. The light shielding plate is arranged between the lens module and the base plate, and defines a second through hole. The image sensor has an exposed portion. The exposed portion has an optically effective region. The first through hole is arranged between the light shielding plate and the effective region. A projection of a border of the second through hole on the exposed surface surrounds a projection of a border of the effective region on the exposed surface, and a projection of a border of the first through hole on the exposed surface surrounds the projection of the border of the second through hole on the exposed surface.

### BACKGROUND

1. Technical Field

The present disclosure relates generally to an image pick-up apparatus having a lens module and an image sensor.

2. Description of Related Art

Image pick-up apparatuses are used in a variety of consumer electronic devices, such as notebook computers, personal digital assistants (PDAs), and cellular telephones. An image pick-up apparatus includes a lens module, a base plate and an image sensor mounted on the base plate. The lens module includes a lens barrel and a number of lenses received in the lens barrel. The base plate is fixed to an end of the lens barrel, and defines a through hole for exposing an optically effective region of the image sensor and allowing light to be transmitted from the lens module onto the effective region of the image sensor. Generally, the effective region of the image sensor has a larger area than that of the through hole. Thus, an inner wall of the base plate adjacent to the through hole may reflect light back onto the effective region of the image sensor, which may cause glare during image capture.

Therefore, there is a need for an image pick-up apparatus, to overcome the above mentioned limitations.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the views.

FIG. 1 is a sectional view of an image pick-up apparatus according to a first exemplary embodiment, comprising a base plate, a first light shielding plate, and an image sensor fixed together.

FIG. 2 is a schematic, isometric view of the first light shielding plate of FIG. 1.

FIG. 3 is a front view of the base plate, the first light shielding plate, and the image sensor fixed together as in FIG. 1, showing a relationship between a first through hole of the base plate, a second through hole of the first light shielding plate, and an effective region of the image sensor.

FIG. 4 is sectional view of a light shielding plate according to a second exemplary embodiment.

### DETAILED DESCRIPTION

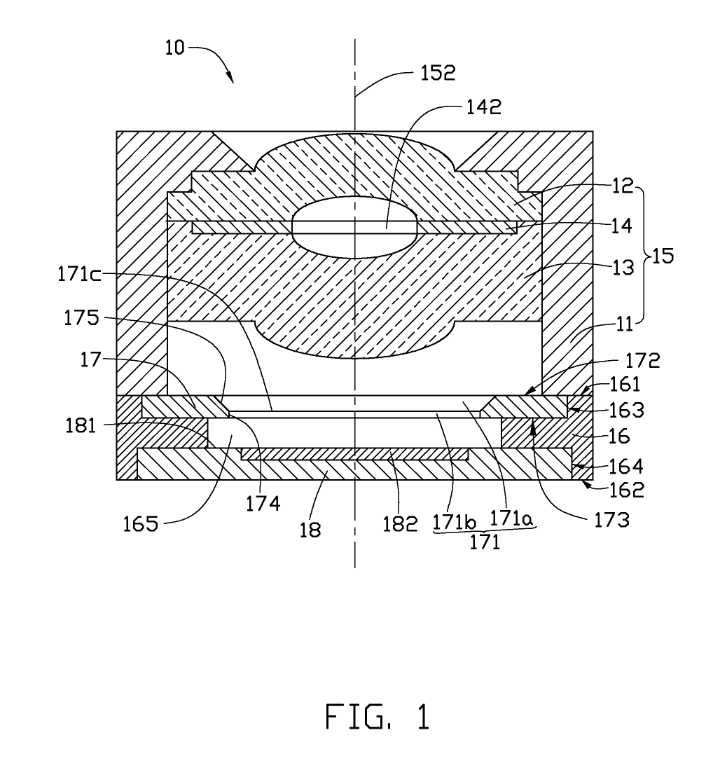

Referring to FIG. 1, an image pick-up apparatus 10 according to a first exemplary embodiment includes a lens module 15, a base plate 16, a first light shielding plate 17, and an image sensor 18. The lens module 15 includes a lens barrel 11, a first optical lens 12, a second optical lens 13, and a second light shielding plate 14.

The first optical lens 12 and the second optical lens 13 are optically aligned with each other about an optical axis 152. The second light shielding plate 14 is arranged between the first and second optical lenses 12 and 13 and is aligned with the first and second optical lenses 12 and 13 along the optical axis 152. The second light shielding plate 14 defines a round through hole 142 at the center thereof for allowing the passage of light. The first optical lens 12, the second optical lens 13, and the light shielding plate 14 are received in the lens barrel 11. The first and second optical lenses 12 and 13 focus light passing therethrough.

The base plate 16 has a first surface 161, an opposite second surface 162, a first hole 163 defined in the first surface 161, a second hole 164 defined in the second surface 162, and a through hole 165 interconnecting the first hole 163 and the second hole 164. The first hole 163, the second hole 164 and the through hole 165 each have a rectangular cross-section and are aligned with each other. The first hole 163 and the second hole 164 have larger areas than that of the through hole 165. The first surface 161 of the base plate 16 is attached to an end of the lens barrel 11 so that the base plate 16 is fixed to the lens barrel 11. In this embodiment, the base plate 16 is comprised of ceramic material.

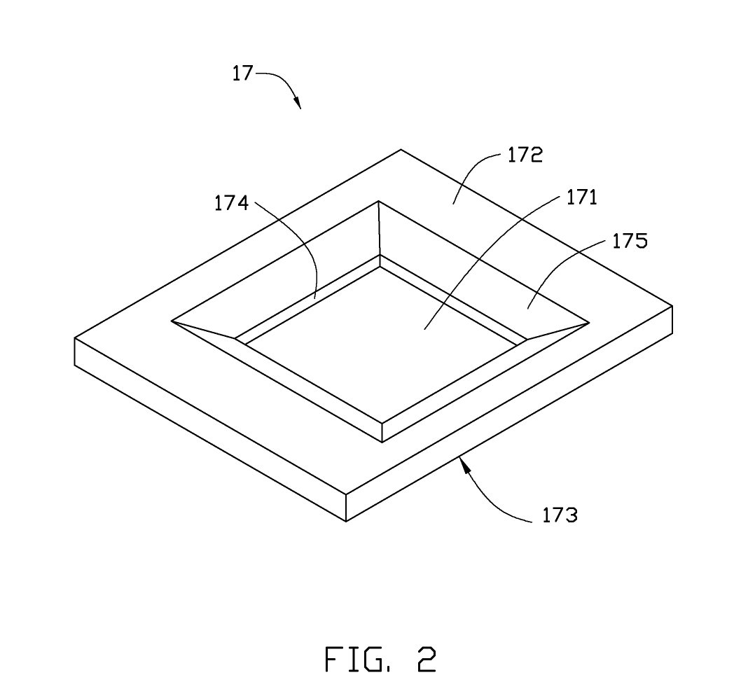

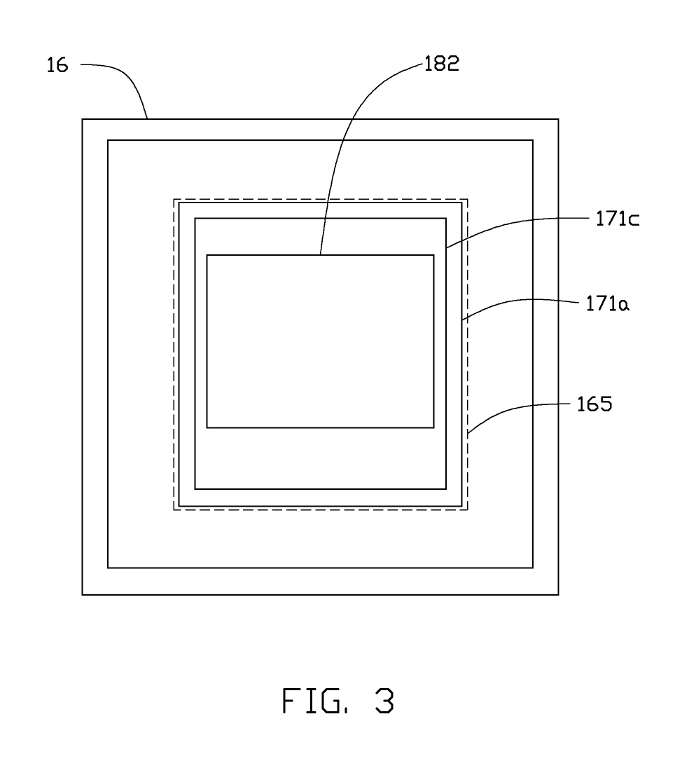

Referring also to FIG. 2, the first light shielding plate 17 is rectangular, and is received in the first hole 163. In this embodiment, the first light shielding plate 17 is attached to the surface of the base plate 16 in the first hole 163. The first light shielding plate 17 has a third surface 172 facing toward the lens barrel 11 and a fourth surface 173 facing away from the third surface 172. The first light shielding plate 17 defines a through hole 171 at the center thereof and through the third surface 172 and the fourth surface 173. The through hole 171 includes a third hole 171 a adjacent to the third surface 172, and a fourth hole 17 lb adjacent to the fourth surface 173. The third hole 171a and the fourth hole 171b each have a rectangular cross section. The third hole 171a and the fourth hole 171b are aligned with each other along the optical axis 152 and in communication with each other. An imaginary border 171C between the third hole 171a and the fourth hole 171b is formed between the third surface 172 and the fourth surface 173. The third hole 171 a tapers from the third surface 172 to the border 171c, thus a pyramid surface 175 is defined in the third hole 171a. The fourth hole 171b has a shape of rectangular parallelepiped, thus an inner surface 174 with a shape of rectangular parallelepiped is defined in the fourth hole 171b. The inner surface 174 is parallel with the optical axis 152. Referring to FIG. 3, the fourth hole 171b has a smaller cross section than that of the through hole 165.

The image sensor 18 is fixed in the second hole 18. In this embodiment, the image sensor 18 is fixed to the base plate 16 by soldering. The image sensor 18 has a surface 181 facing toward the lens module 15 and a rectangular optically effective region 182 defined in the surface 181. The optically effective region 182 has a smaller area than the cross section of the through hole 165 and the cross section of the fourth hole 17 lb. Referring to FIG. 3, in a projection plane perpendicular to the optical axis 152, a border of the fourth hole 171b surrounds a border of the optically effective region 182, and a border of the through hole 165 surrounds the border of the fourth hole 171b.

In this embodiment, most of light striking the inner surface of the first light shielding plate 17 in the through hole 171 is reflected by the pyramid surface 175, and less light is reflected onto the optically effective region 182. Also, because the fourth hole 171b has a smaller cross section than that of the through hole 165, less light can reach the surface of the base plate 16 in the through hole 165. Thus, less light is reflected by the surfaces in the through holes 171 and 165 onto the optically effective region 182 of the image sensor 18 and thereby, any glare present in the image pick-up apparatus 10 is effectively reduced.

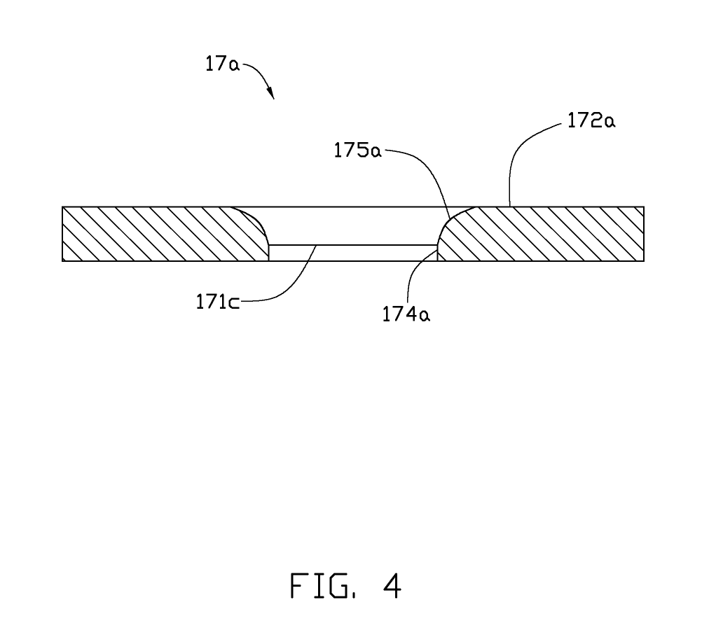

Referring to FIG. 4, a first light shielding plate 17a is provided according to a second exemplary embodiment. The first light shielding plate 17a can be utilized instead of the first light shielding plate 17 of the image pick-up apparatus 10. The first light shielding plate 17a is distinguished from the first light shielding plate 17 in that the third hole 175a of the first light shielding plate 17a is curved from a third surface 172a to a border 171c between the third hole 175a and the fourth hole 174a. The third hole 175a tapers from the third surface 172a to the border 171c.

It is understood that the first light shielding plate 17 or 17a can also be arranged in the first hole 163 with the third surface 172/172a facing away from the lens module 15.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

What is claimed is:

1. An image pick-up apparatus:
a lens module comprising a lens barrel and an optical lens, the optical lens having an optical axis;
a base plate having a first surface facing toward the lens module, and an opposite second surface, the base plate having a hole portion defining a first through hole defined between the first surface and the second surface;
a light shielding plate arranged between the lens module and the hole portion, the light shielding plate having a third surface, and an opposite fourth surface and a second through hole running through the third surface and the fourth surface; and
an image sensor fixed to the base plate, the first through hole being arranged between the light shielding plate and the image sensor, the image sensor having an exposed portion in the first through hole, the exposed portion having an optically effective region, the first through hole, the second through hole and the effective region being aligned with each other along the optical axis, a projection of a border of the second through hole on the exposed surface surrounding a border of the effective region, and a projection of a border of the first through hole on the exposed surface surrounding the projection of the border of the second through hole on the exposed surface.

2. The image pick-up apparatus of claim 1, wherein the light shielding plate comprises a first hole adjacent to the third surface and a second hole adjacent to the fourth surface, the first hole and the second hole are aligned with each other and in communication with each other, the first hole tapering from the third surface to a border between the first and second holes, and the second hole has an inner surface parallel with the optical axis.

3. The image pick-up apparatus of claim 2, wherein the first hole has a rectangular cross section, and the second hole has a shape of rectangular parallelepiped.

4. The image pick-up apparatus of claim 3, wherein the first hole is pyramidal or is curved from the third surface to a border between first hole and the second hole.

5. The image pick-up apparatus of claim 3, wherein the third surface faces toward the lens module.

6. The image pick-up apparatus of claim 1, wherein base plate is comprised of ceramic material.

7. The image pick-up apparatus of claim 1, wherein the base plate defines a first hole in the first surface in communication with the first through hole, the light shielding plate is received in the first hole.

8. The image pick-up apparatus of claim 7, wherein the base plate further defines a second hole in the second surface in communication with the first through hole, the image sensor is received in the second hole.
